(19) United States
(12) Patent Application Publication
(10) Pub. No.: US 2022/0237425 A1
(43) Pub. Date: Jul. 28, 2022

(54) SECURITY TAG

(71) Applicant: Sekura Global IP LLP, Colchester (GB)

(72) Inventor: Chris NAPTHINE, Colchester (GB)

(73) Assignee: Sekura Global IP LLP, Colchester (GB)

(21) Appl. No.: 17/595,771

(22) PCT Filed: May 22, 2020
(86) PCT No.: PCT/GB2020/051263

§ 371 Date: Nov. 24, 2021

(30) Foreign Application Priority Data
May 24, 2019 (GB) 1907411.1

(51) Int. Cl. G06K 19/077

(52) U.S. Cl. CPC G06K 19/07758; G08B 3/00

(57) ABSTRACT

This disclosure relates to security tags and in particular to electronic article surveillance (EAS) tags that are applied to items in a retail environment to deter theft of the items. A security tag comprises a main body, a tamper element and circuitry housed in the main body, the main body being connectable to the tamper element such that the tamper element completes a tamper circuit. The circuitry comprises an alarm system configured to be triggered when the tamper circuit is opened, a switch having a first state in which the alarm system is activated and a second state in which the alarm system is deactivated, and a latch element arranged to detect the state of the switch and being configured such that when the state of the switch changes from the first state to the second state the alarm system is permanently disabled.

### FIELD OF THE DISCLOSURE

This disclosure relates to security tags and in particular to electronic article surveillance (EAS) tags that are applied to items in a retail environment to deter theft of the items. In particular this disclosure relates to security tags that are deactivated by application of a magnetic field.

### BACKGROUND

There are a number of known systems for deterring or preventing theft of articles from a retail environment. Typically these systems include an electronic article surveillance (EAS) tag that is attached to the article or object in a retail store. While the EAS tag is activated, the tag is arranged to trigger an alarm if the tag, and therefore the article, passes between a pair of detection gates, which are typically positioned at the entrance and exit of the retail store.

One known EAS tag is commonly referred to as a hard tag and includes an acousto-magnetic sensor in a hard, or semi-rigid, plastic body. Such hard tags are typically physically or mechanically attached to an article by means of a pin, cable or lanyard. When the article is purchased, the tag is detached from the article by a detacher located at the point of sale so that the alarm is not triggered when that person leaves the retail store. Hard tags that are deactivated and removed completely from the article are re-usable.

A disadvantage of traditional hard tags is that they have to be removed by store associates which has sometimes caused delays at the checkout. Additionally, the store assistants are spending time applying and removing tags from items when that time is better spent providing customer service. Furthermore, time and space must be given to the storage and recycling of the tags.

An acousto-magnetic (AM) EAS label includes a ferromagnetic or ferrimagnetic amorphous metal strip, which has magnetostrictive properties. Typically this amorphous metal strip will be a ferrite. The detection gates at the entrance and exit of the retail store emit periodic tonal bursts at around 58 kHz. This is the same as the resonant frequency of the amorphous metal strip or ferrite, which causes the amorphous strip to vibrate which leads to a change in its magnetisation. This change in magnetisation induces an AC voltage in a receiver antenna of the detection gate, which triggers an alarm.

When a customer purchases an article having one of these EAS labels attached to it, the label is deactivated by changing the magnetisation of part of the label so that the alarm is not triggered when that person leaves the retail store. The label, however, remains attached to the article and is, therefore, single use or disposable.

Traditionally, hard tags are applied to higher cost items and larger articles, while AM labels are typically attached to smaller, lower cost items.

Recently there has been an increase in the use of self-service checkouts in retail stores. A disadvantage of the present systems is that there is a need for an assistant to deactivate and/or remove any security tags that are attached to items being purchased. It would be desirable if a customer could deactivate the security tag at the point of sale without requiring assistance.

Furthermore, it would be desirable to provide a security tag that could be removed by the customer at home after purchase of the item. This would mean that store assistants were no longer spending time removing tags at checkouts.

It is an object of the present invention to provide a security device that overcomes one of the problems with prior art security tags, whether referred to herein or otherwise.

### SUMMARY OF THE INVENTION

According to an aspect of the invention there is provided a security tag for attachment to an item for protecting the item from theft, the security tag comprising:
a main body;
a tamper element;
circuitry housed in the main body, the main body being connectable to the tamper element such that the tamper element completes a tamper circuit and the circuitry further comprising:
   an alarm system configured to be triggered when the tamper circuit is opened;
   a switch having a first state in which the alarm system is activated and a second state in which the alarm system is deactivated; and
   a latch element arranged to detect the state of the switch and being configured such that when the state of the switch changes from the first state to the second state the alarm system is permanently disabled.

Preferably the tamper element comprises an elongate flexible element. Preferably the tamper element comprises a flexible tape. It will be appreciated that the tamper element is electrically conductive.

The main body preferably comprises a base plate and a cover or lid. Preferably the base plate is attachable to said item and the cover is securable to the base plate. The cover is preferably hinged attached to the base plate.

The switch is preferably a magnetic switch. The switch may be a reed switch. The switch may comprise a microcontroller. The switch may be switched between a first state and a second state in response to a radio frequency signal.

The security tag may further comprise a semi-hard magnetic material disposed in proximity to the switch. The security tag may comprise an AM label, which includes a strip of semi-hard magnetic material.

The security tag may comprise an RF label.

The circuitry preferably includes a buzzer configured to sound when the alarm system or alarm circuit is triggered.

The latch element is preferably in the form of a suitable microcontroller. Preferably the switch is connected to one input of the microcontroller.

According to another aspect of the invention there is provided a method of deterring theft of an object using a security tag, the security tag being according to an aspect of the invention and the method comprising:
attaching the main body of a security tag to the object;
attaching the tamper element of the security tag to the object;
electrically connecting ends of the tamper element to circuitry of the security tag to form a tamper circuit.

Preferably the method comprises attaching the main body to the object in an open configuration, and subsequently closing the main body after the ends of the tamper element have been connected to the circuitry.

### BRIEF DESCRIPTION OF THE DRAWINGS

The invention will now be further described by way of example only and with reference to the accompanying figures, in which:

FIG. 1 is a plan view from above of a main body of a security tag according to a first embodiment of the present invention;

FIG. 2 is a side view of the main body of FIG. 1;

FIG. 3 is a cross-sectional view of the main body along the line III-III of FIG. 1;

FIG. 4 is a cross-sectional view of the main body along the line IV-IV of FIG. 1;

FIG. 5 shows the main body of FIG. 1, with a cover of the main body in an open position, and showing in particular circuitry and an alarm system of the security tag;

FIG. 6 shows the main body of FIG. 5 attached to a box and further shows a tamper element of the security tag in the form of a length of flexible tape partially wrapped around the box and attached at a first end to the main body;

FIG. 7 shows the main body of FIG. 5 attached to a box and further shows a tamper element of the security tag in the form of a length of flexible tape fully wrapped around the box and connected to the circuitry;

FIG. 8 is a schematic diagram showing elements of the circuitry of the security tag of FIG. 1;

FIG. 9 is a circuit diagram of the circuitry of a security tag according to a second preferred embodiment of the present invention; and

FIG. 10 is a flow chart of a method of using a security tag according to an embodiment of the present invention.

### DESCRIPTION OF THE PREFERRED EMBODIMENTS

A security tag according to a preferred embodiment of the present invention comprises a main body and a tamper element.

An alarm system and associated circuitry is housed in the main body of the tag and is connected to the tamper element. The tamper element is securable to an object such as a box or other packaging in such a way that the object cannot be opened or used without breaking or damaging the tamper element.

In use, the security tag is secured to an object and the alarm system is activated. If a person attempts to remove the tag or open the object by breaking or damaging the tamper element the alarm is triggered. Preferably the alarm is an audible alarm. When a person purchases the object the alarm system is deactivated. The tag can then be removed from the object without triggering the alarm.

It is envisaged that a security tag according to the present invention will be advantageous in situations in which a customer is purchasing an item at a self-service checkout. In these situations it will be possible for the customer to deactivate the alarm system using a deactivator located at the checkout. The customer can then take the item home and remove the tag later when the customer wishes to open or use the object.

In order to be able to provide a security tag which can be removed by the customer at home, it is desirable to deactivate the alarm system in such a way that it does not reactivate after the customer has left the store. It would be very negative experience for a customer to get home and the alarm be triggered with no way of stopping it.

Accordingly, the circuitry of the security tag of the present invention further comprises a latching element that is configured to prevent the alarm system being re-activated after the alarm system has been deactivated once. In this way the security tag of the present invention is single use or disposable.

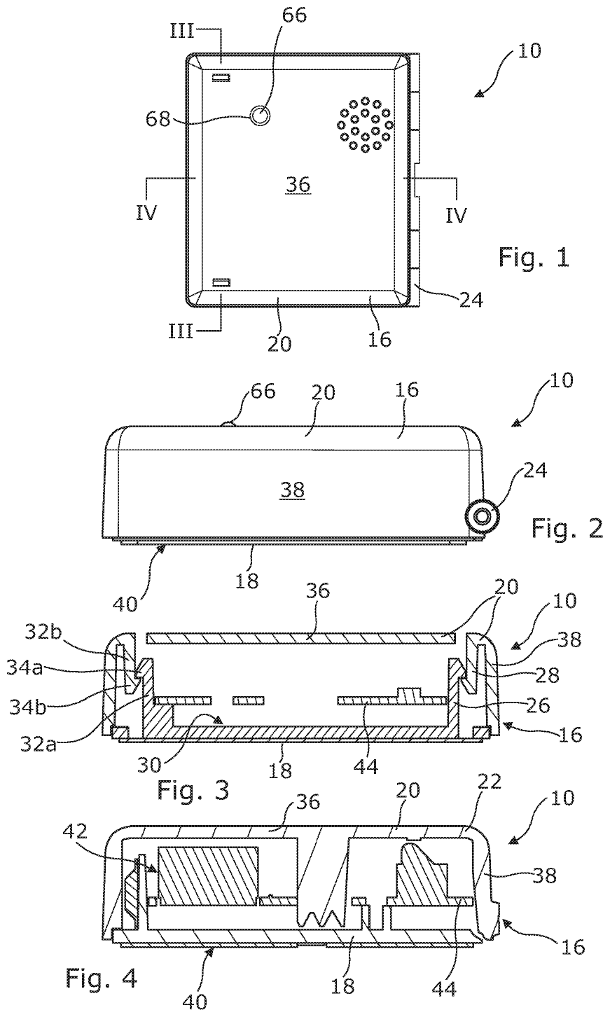

Referring now to FIGS. 1 to 8, a first preferred embodiment of the security tag 10 will be described. In this embodiment the security tag 10 is designed to be applied to a box 2 and to deter or prevent opening of the box 2 while the security tag 10 is activated. In will be appreciated, however, that in other embodiments the security tag 10 may be attached to other objects or items.

The security tag 10 comprises a tamper element 12 in the form of an elongate flexible tape or strap 14 that may be wrapped around the box 2. Preferably the tape 14 is an adhesive tape so that it may be adhered to a surface of the box 2 to further hinder removal of the security tag 10 from the box 2. The tamper element 12 includes an electrically conductive element extending along the full length of the tamper element 12. The conductive element may be in the form of a metallic strip or metallic wire.

A main body 16 of the security tag 10 comprises a base plate 18 and a cover 20. The base plate 18 and cover 20 together define a housing 22 having an interior volume. The cover 20 and base plate 18 are preferably configured such that the cover 20 may be moved relative to the base plate 18 to access the interior volume of the housing 22. The cover 20 is movable between an open position in which the interior volume of the housing 22 is accessible and a closed position in which the interior volume of the housing 22 cannot be accessed. In this embodiment the cover 20 is hingedly secured to the base plate 18.

In this embodiment the base plate 18 is rectangular. The cover 20 is secured to the base plate 18 along one edge of the base plate 18 by a suitable hinge 24.

It is advantageous if the cover 20 cannot be easily opened once it has been closed to prevent a person tampering with the contents of the main body 16 (described further below). Accordingly, the base plate 18 and the cover 20 are preferably provided with complementary closure elements 26, 28 that are configured to retain the cover 20 in its closed position and which cannot be subsequently disengaged to move the cover 20 back to the open position. In the illustrated embodiments, and as shown most clearly in FIG. 3 a first closure element 26 extends from a first surface 30 of the base plate 18. The first closure element 26 comprises a stem 32a extending from the base plate 18 and a hook or barb 34a at a distal end of the stem 32a. Similarly, the cover 20 includes a second closure element 28 comprising a stem 32b and a hook or barb 34b at a distal end of the stem 32b. The first and second closure elements 26, 28 are arranged such that when the cover 20 is moved into the closed position the hook 34a of the first closure element 26 engages with the hook 34b of the second closure element 28 to retain the cover 20 in the closed position.

The hooks 34a, 34b of the first and second closure elements 26, 28 preferably cannot be disengaged without damaging a part of the cover 20. In this embodiment the cover 20 comprises a substantially rectangular top wall 36 and a perimeter side wall 38 that extends from edges of the top wall 36. The second closure element 28 is disposed inwardly of the side wall 38 of the cover 20. Furthermore, when the cover 20 is engaged with the base plate 18 in the closed position the first closure element 26 is also disposed inwardly of the side wall 38 of the cover 20. The side wall 38 of the cover 20 therefore surround the closure elements 26, 28 when the cover 20 is in the closed position. In this way the closure elements 26, 28 cannot be freely accessed without breaking or damaging a part of the main body 16 of the security tag 10.

The base plate 18 of the security tag 10 is preferably provided with an adhesive layer on a second surface 40 of the base plate 18 to enable the base plate 18 of the tag 10 to be adhered to an object such as a box 2. The base plate 18 may comprise a continuous adhesive layer or discrete adhesive regions. In other embodiments the base plate or the main body of the security tag may comprise other means to attach or affix the main body of the tag to an object. These other means may comprise, for example, a strap, a band, or a mechanical fastener.

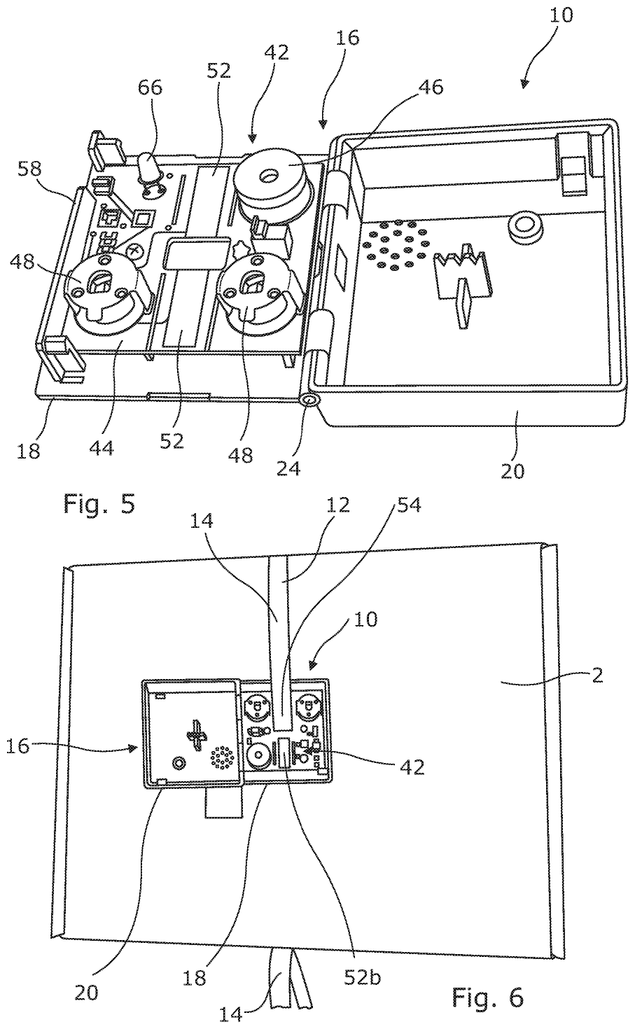

The main body 16 of the security tag 10 houses circuitry 42 including an alarm system. Referring now in particular to FIGS. 5 to 8, in a first preferred embodiment the circuitry 42 comprises a circuit board 44, a buzzer or sounder 46, a power source 48, a switch 50 and a pair of conductive contacts 52. The power source 48 preferably comprises a battery.

The conductive contacts or contact pads 52 are arranged to electrically connect to ends 54, 56 of the tamper element 12. In particular, in use, a first end 54 of the tamper element 12 is connected to a first conductive contact 52a and a second end 56 of the tamper element 12 is connected to a second conductive contact 52b. When the tamper element 12 is connected to the conductive contacts 52 it completes a tamper circuit which is electrically connected to the alarm circuit of the security tag 10.

The alarm circuit and tamper circuit are configured such that if the tamper element 12 is cut or otherwise broken at any point along its length the tamper circuit is opened.

The alarm circuit further comprises the switch 50 which has a first state in which the alarm system is activated and a second state in which the alarm system is deactivated.

In use, when the switch 50 is in the first state such that the alarm circuit is activated, if the tamper element 12 is broken so as to open the tamper circuit, the alarm circuit is triggered. The alarm circuit preferably further comprises the buzzer or sounder 46. When the alarm circuit is triggered the buzzer 46 is configured to emit an audible sound.

To enable the tamper element 12 to be broken or removed without sounding the alarm, the alarm circuit must be deactivated. This is done by switching the switch 50 to the second state. Preferably the switch 50 is a magnetic switch. The switch 50 may comprise a reed switch. Accordingly, the switch 50 may be switched from the first state to the second state by application of a suitable magnetic force to the switch 50. This may be achieved by placing a magnet in the vicinity of the main body 16 of the security tag 10 such that the switch 50 is disposed in the magnetic field of the magnet.

In a preferred embodiment the security tag 10 further comprises a piece or strip of a semi-hard magnetic material 58. This strip of magnetic material 58 is disposed adjacent or proximate the magnetic switch 50. The magnetic state of the strip of magnetic material 58 is alterable or changeable by the application of a magnetic field to the strip of magnetic material 58. In particular, the magnetic state of the strip of magnetic material 58 preferably changes from a first magnetic state to a second magnetic state upon application of a magnetic field to the strip of magnetic material 58. Preferably the strip of magnetic material 58 is configured such that it is unable to transition from the second magnetic state to the first magnetic state.

The configuration and arrangement of the strip of magnetic material 58 and the switch 50 is such that a change in the magnetic state of the strip of magnetic material 58 causes the switch 50 to switch from its first state to its second state. In particular, the magnetic state of the strip of magnetic material 58 changing from the first magnetic state to the second magnetic state preferably causes the switch 50 to switch from it first state to its second state.

It will be appreciated that, in this embodiment, although subsequent application of a magnetic field to the strip of magnetic material 58 may not cause the magnetic state to change from the second magnetic state to the first magnetic state, the magnetic field may act directly on the magnetic switch 50. Accordingly, the magnetic field may cause the magnetic switch 50 to switch from the second state to the first state. The alarm system may therefore be re-activated upon accidental or inadvertent application of a magnetic field to a security tag 10 that had previously be deactivated.

To prevent this occurring, the circuitry 42 of the security tag 10 of the present invention comprises a latch element 60. The latch element 60 is configured to detect the state of the switch 50 and to transition from a first, enabled state to a second, disabled state when the switch 50 switches from its first state to its second state. The latch element 60 is configured such that it is unable to transition from the second state to the first state.

In preferred embodiments the latch element 60 comprises a microcontroller or micro control unit (MCU) 62. The microcontroller 62 is configured such that the switch 50 is connected to one input of the microcontroller 62.

In use, the security tag 10 is attached to an object with the strip of magnetic material 58 in its first magnetic state, the switch 50 in its first state and the latch element 60 in its enabled state. In this activated configuration the alarm will be triggered and the buzzer 46 will sound if the tamper element 12 is cut or broken as described above. When the object is purchased the security tag 10 is deactivated, in this embodiment, by applying a magnetic field to the security tag 10. The magnetic field causes the strip of magnetic material 58 to transition to its second magnetic state, the switch 50 to switch to its second state and the latch element 60 to switch to its disabled state. In this deactivated configuration the buzzer 46 will not sound if the tamper element 12 is cut or broken, and furthermore, the latch element 60 is permanently switched to its disabled state such that even if the switch 50 switches to its first state, the buzzer 46 will not sound if the tamper element 12 is cut or broken. The security tag 10 is therefore permanently disabled or deactivated.

In a preferred embodiment of the invention the strip of magnetic material 58 is provided by an acousto-magnetic (AM) label 64 attached to the main body 16 of the security tag 10. The AM label 64 is preferably a standard AM label 64 well known in the industry and its features and function will not be described in detail.

The incorporation of the AM label 64 into the security tag 10 of the present invention has the additional advantage that the security tag 10 is detectable by suitable detectors positioned at the entrance and exit of the store. If the security tag 10 passes close to a detector, for example if a person attempts to remove an item from the store, while the AM label 64 is activated, the detectors will sound an alarm or otherwise alert security personnel, in a manner known in the art.

A traditional and known AM label deactivator may, therefore, be located at a point of sale to deactivate the AM label 64. The process of deactivating the AM label 64 causes a change in the magnetic state of the strip of semi-hard magnetic material 58 within the AM label 64. Accordingly, deactivating the AM label 64 also causes the strip of magnetic material 58 to transition to its second magnetic state, the switch 50 to switch to its second state and the latch element 60 to switch to its disabled state. This, therefore, disables or deactivates the alarm circuitry in the main body 16 of the security tag 10.

In preferred embodiments therefore the security tag 10 includes two means of triggering an alarm, namely by:
1) breaking or damaging the tamper element 12 such that the alarm circuit housed within the main body 16 is triggered; and
2) passing the AM label 64 close to a suitable detector, for example positioned at the exit of the store.

Furthermore, a single deactivator, such as a known AM label deactivator, may be used to disable both means of triggering an alarm in a single step.

Although in the embodiment described above the switch 50 was a magnetic switch, it will be appreciated that in other embodiments the switch 50 may be of any suitable type. The switch 50 may be in the form of a microcontroller. The switch 50 is preferably switchable from a first state to a second state by application of a deactivator to the security tag. The deactivator may emit, for example, a magnetic field, a radio frequency signal, or a microwave signal.

In another embodiment of the security tag the switch 150 may be switchable from the first state to the second state in response to a radio frequency (RF) signal. In these embodiments the switch 150 may be in the form of a suitable RF microcontroller 150.

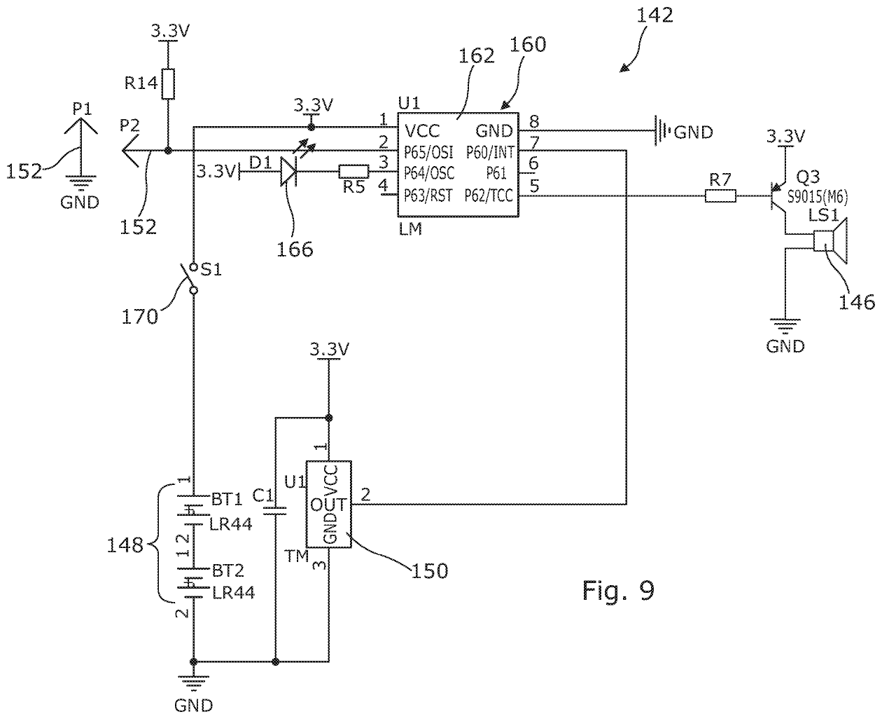

FIG. 9 illustrates an embodiment of a circuit 142 of a security tag according to the present invention that includes a switch 150 in the form of an RF microcontroller 150. As described above, the alarm circuit of this embodiment also includes a buzzer 146, a pair of conductive contacts 152, a power source in the form of a battery 148 and a latch element 160 in the form of a suitable microcontroller 162.

In these embodiments the security tag may further comprise an RF label, as is known in the art. The incorporation of the RF label into this embodiment of the security tag has the additional advantage that the security tag is detectable by suitable detectors positioned at the entrance and exit of the store. If the security tag passes close to a detector, for example if a person attempts to remove an item from the store, while the RF label is activated, the detectors will sound an alarm or otherwise alert security personnel, in a manner known in the art.

A traditional and known RF label deactivator may, therefore, be located at a point of sale to deactivate the RF label. The process of deactivating the RF label also causes the switch 150 to switch to its second state and the latch element 160 to switch to its disabled state. This, therefore, disables or deactivates the alarm circuitry in the main body of the security tag.

In preferred embodiments therefore the security tag includes two means of triggering an alarm, namely by:
1) breaking or damaging the tamper element such that the alarm circuit housed within the main body is triggered; and
2) passing the RF label close to a suitable detector, for example positioned at the exit of the store.

Furthermore, a single deactivator, such as a known RF label deactivator, may be used to disable both means of triggering an alarm in a single step.

In both of the embodiments of the security tag 10 described above the circuitry 42, 142 further includes a light emitter 66, 166. Preferably the light emitter 66, 166 is in the form of a light emitting diode (LED). The light emitter 66, 166 may be configured to emit light when the alarm circuit is activated and to turn off when the alarm circuit is deactivated or disabled. Alternatively the light emitter 66, 166 may be configured to emit light when the alarm circuit is triggered. The light emitter 66, 166 may be configured to change state when the alarm circuit is triggered. For example, the light emitter 66, 166 may emit a constant light when the alarm circuit is activated and the light emitter 66, 166 may flash when the alarm circuit is triggered.

In embodiments including a light emitter 66, 166, the cover 20 may include an aperture 68 which is aligned with the light emitter 66 when the cover 20 is in the closed position. A part of the light emitter 66 may protrude through the aperture 68 when the cover 20 is in the closed position.

The circuitry 42, 142 of an embodiment of the security tag 10 may further include a power switch 70, 170. This power switch 70, 170 is configured to control the power supplied to the alarm circuitry. In particular, this switch 70, 170 may be used to switch the security tag 10 on when it is first applied to an object. Preferably the power switch 70, 170 is housed within the housing 22 of the security tag 10 such that the power switch 70, 170 is not accessible when the cover 20 of the main body 16 is closed.

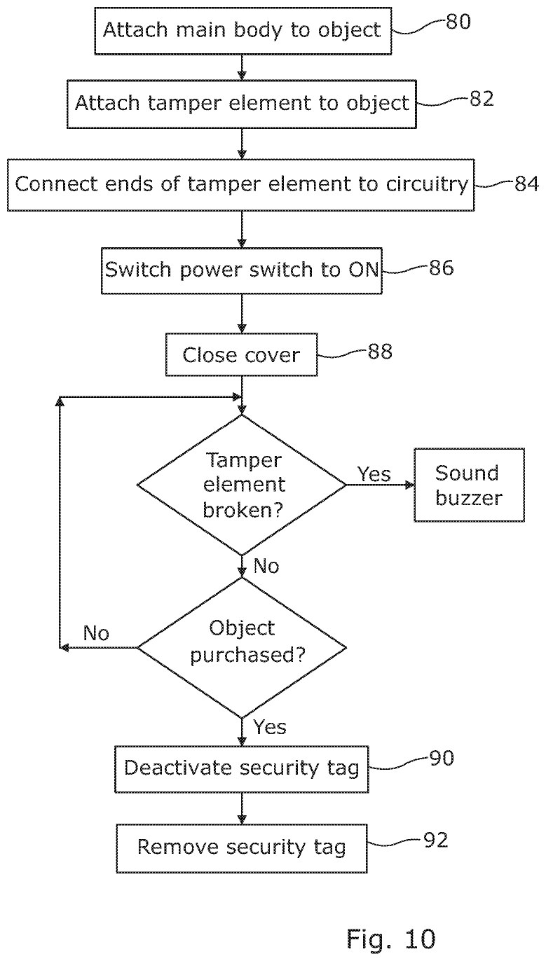

The application of the security tag 10 to an object and the use of the security tag 10 to deter theft of the object from a retail store will now be described with particular reference to FIGS. 6, 7 and 10.

In a first step 80, the main body 16 of the security tag 10 is attached to a surface of the object to be protected. Preferably the base plate 18 of the main body 16 is attached to the object. Preferably the main body 16 is adhered to the object by a suitable adhesive. The main body 16 is attached to the object with the cover 20 in an open position so that the contents of the main body 16, and in particular the circuitry 42, 142, is accessible.

In a second step 82, the tamper element 12 is applied to the object. Preferably the tamper element 12 comprises a length of adhesive tape 14 which is wrapped around the object, as illustrated in FIG. 6.

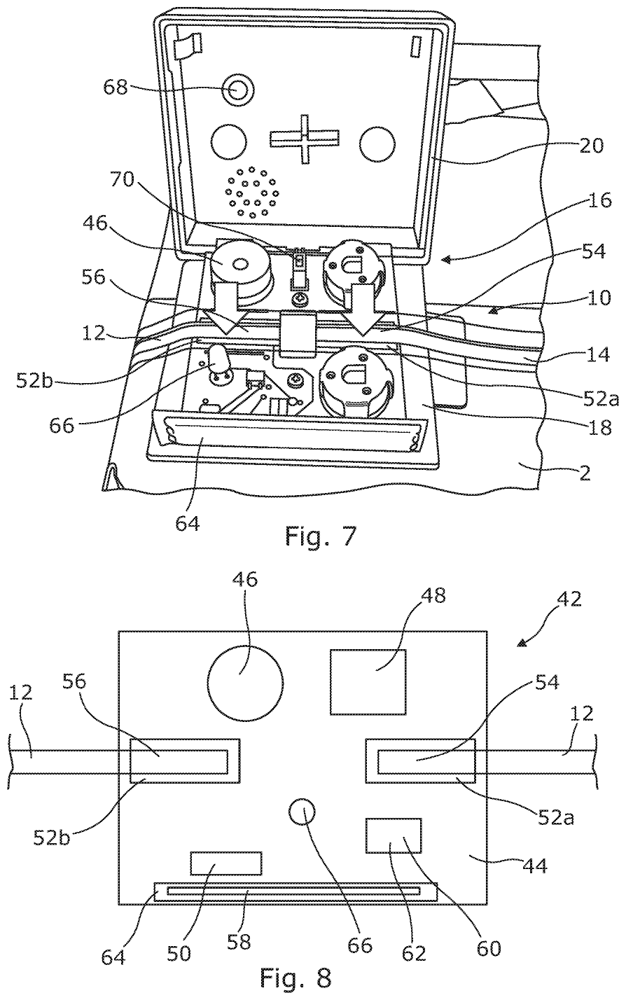

In a further step 84, the first and second ends 54, 56 of the tamper element 12 are connected to the circuitry 42, 142 of the security tag 10. In particular, the first end 54 of the tamper element 12 is connected to the first conductive contact 52a and the second end 56 of the tamper element 12 is connected to the second conductive contact 52b. This is illustrated in FIG. 7. Preferably at least a part of the tamper element 12 at its first and second ends 54, 56 is electrically conductive and the first and second ends 54, 56 of the tamper element 12 may be pressed into contact with the conductive contacts 52, as indicated by the arrows of FIG. 7.

In an optional step 86, before the cover 20 of the main body 16 is closed, a power switch 70, 170 (if provided) may be switched to on to provide power to the circuitry 42, 142.

The cover 20 of the main body 16 is then closed 88 so that the complementary closure elements 26, 28 engage with each other to retain the cover 20 in the closed position. The cover 20 may additionally comprise press elements that apply a force to the first and second ends 54, 56 of the tamper element 12 to ensure a good electrical contact is maintained between the tamper element 12 and the conductive contacts 52. The press elements may be in the form of one or more posts or protrusions extending from an internal surface of the cover 20.

The security tag 10 is now attached to the object and is in an activated configuration. In this configuration the switch 50, 150 is in its first state and the latch element 60, 160 is in its first, enabled state.

If a person attempts to remove the security tag 10 from the object or attempts to open the object and therefore breaks the tamper element 12, the alarm circuit will be triggered and the buzzer 46 will sound.

In embodiments comprising an AM label 64 or an RF label, if a person attempts to remove the object from the store with the activated security tag 10 attached, suitable detectors positioned at the exit of the store will detect the security tag 10 and will trigger an alarm and/or otherwise alert security personnel.

When a customer purchases the object the security tag 10 can be deactivated 90.

If the customer uses a traditional checkout, store staff pass the security tag 10 over a suitable deactivator, such as an AM deactivator or an RF deactivator. As described above, the deactivator deactivates any AM label 64 or an RF label that may be attached to the security tag 10 and causes the switch 50, 150 to switch to its second state. The switch 50, 150 switching to the second state causes the latch element 60, 160 to transition to its second, disabled state.

The security tag 10 is then permanently disabled. Even if the switch 50, 150 returns to its first state, for example by application of a magnetic field, the alarm circuit cannot be triggered due to the latch element 60, 160 being in its second state. The tamper element 12 can therefore be cut or otherwise broken to allow the security tag 10 to be removed 92 from the object, or the object to be opened, without triggering the alarm.

If a customer uses a self-service checkout, the self-service checkout may be equipped with a suitable AM or RF deactivator. Once the customer has completed their purchase they are then, preferably, able to pass the security tag 10 over the deactivator to disable the security tag 10.

Because the security tag 10 is permanently disabled when it is deactivated it is not necessary to remove the security tag 10 in store. The customer can therefore remove the object from the store with the disabled security tag 10 still attached. The security tag 10 may then be removed from the object at a later time, and importantly the security tag 10 may be removed by the customer.

This therefore avoids the requirement for store staff to remove security tags at self-service checkouts. Furthermore, because the security tag 10 is permanently disabled there is no likelihood of the alarm being accidentally triggered once the customer has left the store.

It will be appreciated that in other embodiments the tamper element may be of any suitable configuration. Preferably the tamper element is flexible. Preferably the tamper element is elongate. The tamper element may be in the form of a strap, a cord, a tape, a cable, a strip of conductive material, a sheet. The tamper element may include an adhesive for securing the tamper element to an item. The tamper element is electrically conductive and may comprise a metallic element. Alternatively the tamper element may include any other suitable electrically conductive element including a polymeric element or an element including carbon.

It will be appreciated that in other embodiments other forms of closure elements may be provided. The closure elements are preferably configured such that once the cover of the security tag has been closed it cannot subsequently be re-opened without damaging the main body of the security tag. The closure elements may comprise a resilient arm that engages in the recess, or a hook that engages with an undercut.

It will be appreciated that in other embodiments the cover may be fully removable from the base plate. In yet further embodiments other mechanisms may be provide that enable the cover to move between an open position and a closed position.

The present invention therefore provides an improved security tag that may be deactivated and is thereby permanently disabled to prevent accidental triggering of the alarm after deactivation.

1. A security tag for attachment to an item for protecting the item from theft, the security tag comprising:
a main body;
a tamper element;
circuitry housed in the main body, the main body being connectable to the tamper element such that the tamper element completes a tamper circuit and the circuitry further comprising:
an alarm system configured to be triggered when the tamper circuit is opened;
a switch having a first state in which the alarm system is activated and a second state in which the alarm system is deactivated; and
a latch element arranged to detect the state of the switch and being configured such that when the state of the switch changes from the first state to the second state the alarm system is permanently disabled.

2. The security tag of claim 1, in which the tamper element comprises an elongate flexible element.

3. The security tag of claim 2, wherein the tamper element comprises a flexible tape.

4. The security tag of claim 1, in which the main body comprises a base plate and a cover, and wherein the base plate is attachable to said item and the cover is securable to the base plate.

5. The security tag of claim 4, wherein the cover is hingedly attached to the base plate.

6. The security tag of claim 1, in which the switch is a magnetic switch.

7. The security tag of claim 6, wherein the switch is a reed switch.

8. The security tag of claim 6, wherein the security tag comprises a semi-hard magnetic material disposed in proximity to the switch.

9. The security tag of claim 6, wherein the security tag comprises an acousto-magnetic (AM) label.

10. The security tag of claim 1, wherein the switch comprises a microcontroller.

11. The security tag of claim 1, wherein the switch is configured to be switched between a first state and a second state in response to a radio frequency signal.

12. The security tag of claim 11, wherein the security tag comprises a radio frequency (RF) label.

13. The security tag of claim 1, wherein the circuitry includes a buzzer configured to sound when the alarm system is triggered.

14. The security tag of claim 1, wherein the latch element comprises a microcontroller.

15. A method of deterring theft of an object using a security tag, the security tag being according to claim 1 and the method comprising:
attaching the main body of the security tag to the object;
attaching the tamper element of the security tag to the object;
electrically connecting ends of the tamper element to circuitry of the security tag to form a tamper circuit.

16. The method of claim 15, wherein the method comprises attaching the main body to the object in an open configuration, and subsequently closing the main body after the ends of the tamper element have been connected to the circuitry.
